(19) United States
(12) Patent Application Publication
(10) Pub. No.: US 2007/0128912 A1
(43) Pub. Date: Jun. 7, 2007

(54) PRESS CONNECTION ARRANGEMENT AND METHOD FOR PRODUCING A PRESS CONNECTION ARRANGEMENT

(75) Inventors: Alan Richard Glaze, Bromsgrove (GB); Steven Paul Webb, Tipton (GB)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: IBP CONEX LIMITED, Tipton (GB)

(21) Appl. No.: 11/674,097

(22) Filed: Feb. 12, 2007

Related U.S. Application Data
(63) Continuation of application No. PCT/EP05/08029, filed on Jul. 22, 2005.

(30) Foreign Application Priority Data
Aug. 12, 2004 (EP) 04019192.6

(51) Int. Cl. H01R 13/62

(52) U.S. Cl. 439/320

(57) ABSTRACT

A method for producing a press connection arrangement comprises connecting a body to a socket to form a unit, inserting an end of a tube into at least a part of the unit, and press-connecting the socket onto the tube in the area of a bead provided by the socket to house a sealing element between the socket and the tube and obtain a press connection arrangement being fluid tight. The element of connecting the body to the socket further comprises screwing a thread of the body onto a thread of the socket and, at least partially deforming the mating threads to create an anti-rotational lock. A press connection arrangement produced by such a method is also defined.

### FIELD

The present application refers to a method for producing a press connection arrangement, comprising the steps of (a) connecting a body to a socket to form a unit of the body and the socket, wherein the body is suited for conditioning a fluid flow within a pipework by re-directing, shutting-off and/or accelerating at least a part of said fluid flow or for providing an adaptation between diameters of different pipework elements, (b) inserting the end of a tube into at least a part of the unit, and (c) press-connecting the socket onto the tube in the area of a bead provided by the socket to house a sealing element between the socket and the tube under the formation of indentations to obtain a press connection arrangement being fluid tight.

### BACKGROUND

From the disclosure in EP 0 507 423 B1, it is known to use a socket in form of a standardized connector for connecting a body in form of a shut-off member of a water and heating plumbing installation to a pipe or tube. The connector is connected to the shut-off member via a soldering joint, welding joint or adhesive layer. All three alternatives have the drawback of requiring additional material, namely a soldering material, welding material or adhesive, in order to ensure a secure connection.

From DE 298 00 861 U1, a press connection arrangement is known which comprises a socket detachably connected to a body either by screwing, latching, catching, pressing, squeezing or based on a bayonet connection. Those connections are not sufficiently secure.

U.S. Pat. No. 6,481,086 B1 discloses a method for sealingly interconnecting a pipe with a structure such that the pipe is axially moveable with respect thereto. This structure uses an annular sealing member onto which a body is screwed such that a pipe inserted into said member can be moved axially.

A method for assembling two carcass ends is known from WO 01/50056, each of said ends comprising a wound profile and the end areas of overlapping profiles of the carcass pipes being fixed to each other by the provision of one or more punctiform deformations in the common, overlapping profiles.

Further development of known methods for producing a press connection arrangement is desired.

### SUMMARY

The following summary is provided to introduce various concepts in a simplified form that are further described below in the Detailed Description. This summary is not intended to identify specific key features of the claimed subject matter.

Described herein is a method and arrangement in which a body is connected to a socket to form a unit of the body and the socket. The body is preferably suited for conditioning a fluid flow within a pipework by re-directing, shutting-off and/or accelerating at least a part of said fluid flow or for providing an adaptation between diameters of different pipework elements. In one aspect, a method described herein further comprises:

screwing a thread of the body onto a thread of the socket, and

at least partially deforming the mating threads to create an anti-rotational lock.

In another aspect, it is proposed that the body and the socket are cast and then machined internally as well as externally.

It is preferred that the threads are machined, in particular the thread of the body being machined on an inner surface of the body and the thread of the socket being machined on an outer surface of the socket.

One embodiment of the invention is characterized in that the end of the body to be screwed onto the socket is formed with an extension of enhanced internal diameter and adjacent to the extension, extending substantially axially, the thread of the body is formed as an internal thread. The end of the socket to be screwed into the body is formed with the thread as an external thread, and adjacent to the external thread, a substantial cylindrical portion, preferably provided with an enhanced external diameter, is bordered by a substantially radially extending projection. A sealing element, in particular in form of an O-ring, is fitted, preferably onto the cylindrical portion of the socket, prior to the assembly of the body and the socket. After screwing the body onto the socket, the sealing element creates a seal between the body and the socket. In one embodiment, the sealing element creates a seal in particular between the extension, the threads, the cylindrical portion and the projection.

In this embodiment, the body may be screwed onto the socket until the extension engages the projection and/or the sealing element is deformed.

In addition, it is proposed herein that the threads are deformed substantially along at least one inner perimeter of the unit and/or by forming at least one dimple into the material of both the socket and the body in the region of their threads. Preferably, a plurality of dimples are formed into the material of the socket and the body in the region of their threads.

In another embodiment, it is proposed that the threads are deformed by pressing material of the socket and the body in the region of their threads from the outside of the unit onto at least one deformation element insertable into the unit.

In this respect, it is further proposed that the step of deforming the mating threads to create an anti-rotational lock further comprises:

inserting the deformation element into the unit, in particular into the socket, preferably by moving the deformation element until it engages the internal surface of the socket opposite the external thread thereof,

applying a pressing action to the outside of the unit opposite the deformation element to force the unit, in particular the material in the region of the threads, onto the deformation element,

relieving the pressing action, and

retracting the deformation element out of the unit.

It is preferred that the step of applying a pressing action is repeated after displacing, preferably by rotating, the deformation element relative to the unit in order to form a plurality of deformations, in particular for forming a plurality of dimples, into the threads.

In another aspect of the invention, a stop member for stopping the insertion of a tube, in particular in form of a region of reduced internal diameter of the socket, is provided on the inner surface of the socket, preferably axially between the projection and the thread.

The thickness of the socket may be reduced in the area of its thread in order to facilitate the deformation thereof, in particular by forming the socket with an enhanced internal diameter, preferably from the end thereof until the stop member.

Still further, the present application refers to a press connection arrangement produced by a method of the invention, with a body, a socket and a tube of a pipework. As implemented, the body may be in the form of an elbow, a T-element, an adaptor, a connector, a valve and/or an armature. The body may be provided with a thread in order to be screwed onto a thread of the socket. Mating threads of the body and the socket are at least partially deformed after assembling the socket and the body in order to provide an anti-rotational lock. The socket may be provided with an annular bead to house a sealing element, in particular in form of an O-ring. The socket is pressed onto the tube in the area of the bead for a fluid tight connection.

One embodiment described herein is characterized by a sealing element, in particular in form of an O-ring, being arranged and/or deformed between the socket and the body. The sealing element is preferably arranged and/or deformed in a space defined between the threads, a substantially axially extending extension of the body, a substantially radially projecting projection of the socket and a substantially cylindrical portion with enhanced external diameter, of the socket. The projection and the extension preferably engage each other.

In yet another aspect, a stop member, in particular in form of a region with reduced internal diameter, is provided on the internal surface of the socket to catch an end of a tube to be inserted into the socket. The stop member is preferably provided between the projection and the thread.

It is preferred that the end of the socket to be connected to the body is provided with a thread, in particular in form of an external thread, said end preferably having a reduced thickness and/or enhanced internal diameter.

In addition, it is proposed that the material of the socket is partially pressed into the material of the body in the region of the threads, in particular in form of at least one dimple.

Finally, it is proposed that a plurality of dimples is provided, preferably arranged along at least one inner perimeter of the socket, most preferably the dimples being displaced around the inner perimeter at substantially 90° relative to each other.

A unique feature of the embodiments described herein is that the socket and the body can be connected via a simple screwing connection to form a unit with a subsequent unscrewing of the unit being prevented by deforming material of the socket and the body in the region of the threads of the screwing connection. The material is deformed at least partially, in particular in form of dimples, to create an anti-rotational lock.

### DESCRIPTION OF THE DRAWINGS

The invention, together with further objects and advantages, may be best understood, by example, with reference to the following description of one embodiment taken together with the accompanying schematic drawings, in which

FIG. 1 is an exploded view of three sockets to be connected to one body of a press connection arrangement of the invention;

FIG. 2 is a partial cross sectional view of a socket assembled with a body shown in FIG. 1;

FIG. 3 is a partial cross sectional view of a socket and a body prior to assembly;

FIG. 4 is an enlarged partial cross sectional view of a unit of a socket and a body;

FIG. 5 is a perspective view of a deformation element and a unit provided by a body and a socket;

FIG. 6 is a partial cross sectional view of the deformation tool and the unit shown in FIG. 5 in cooperation with a pressing tool to deform said unit;

FIG. 7 is a partial cross sectional view of the body and the socket after deformation thereof; and

FIG. 8 is a partial cross sectional view of a press connection arrangement of the invention after assembly.

### DETAILED DESCRIPTION

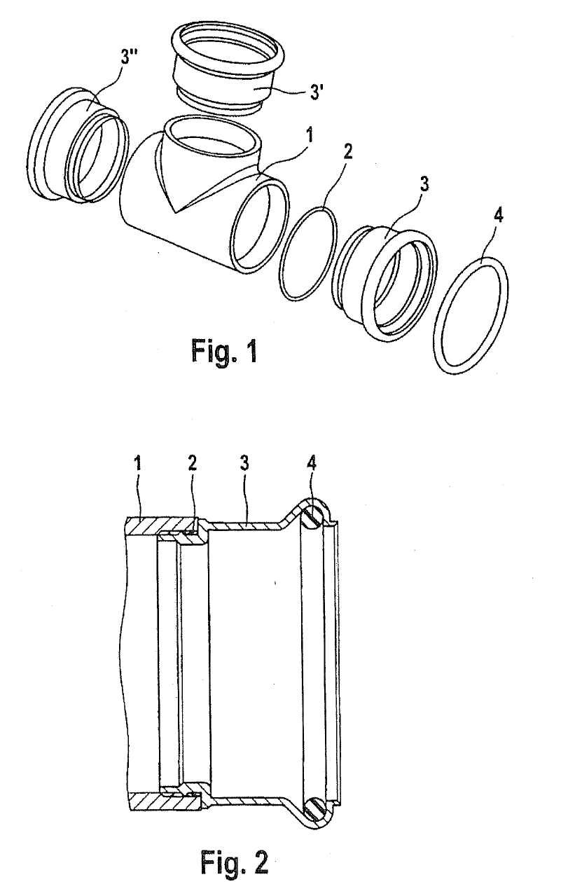

According to FIG. 1, a press connection arrangement of the invention comprises a body 1 in form of a T-element to be connected to three sockets 3, 3′, 3″. One of the sockets, namely socket 3, is connectable at one of its ends to the body 1 after fitting a sealing element 2 in form of an O-ring. The socket 3 is pressable at its other end on a tube, not shown, after fitting a further sealing element 4 in form of an O-ring. A respective connection of the body 1 and the socket 3 with both sealing elements 2, 4 is shown in FIG. 2.

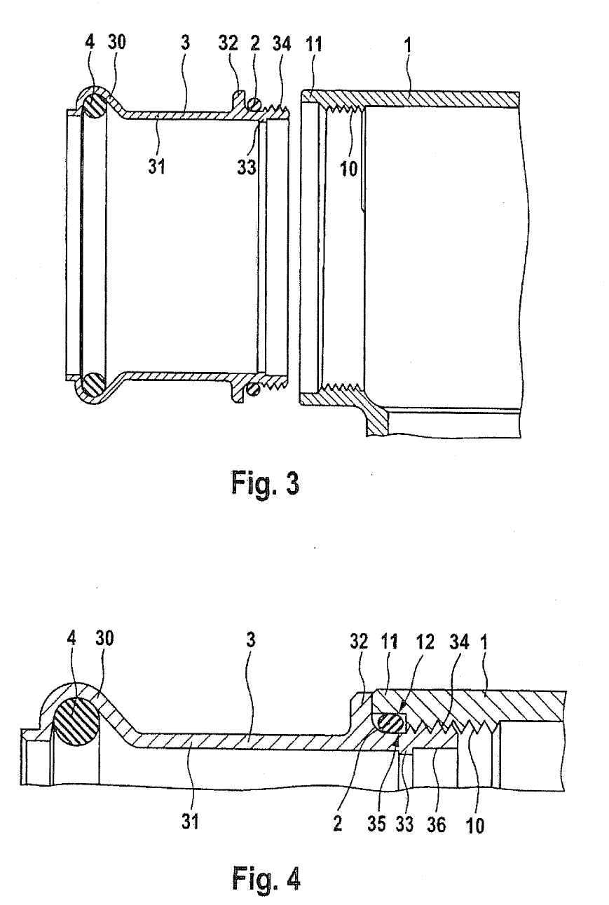

In line with FIGS. 3 and 4, the socket 3 may be cast from a tube-like bar, which may be made out of red brass, for example, and subsequently machined externally as well internally to provide an annular bead 30, a cylindrical portion 31, a substantially radially extending projection 32, an internal stop member 33 as well as an external thread 34. A further cylindrical portion with enhanced external diameter 35 is provided between the projection 32 and the external thread 34 at the end of the socket 3 to be connected to the body 1. Said end of the socket 3 has an enhanced internal diameter 36. Within the annular bead 30, the sealing element 4 to be arranged between the socket 3 and the non-shown tube is housed, said tube being insertable into the socket 3 until it engages the stop member 33.

The body 1 may also be produced by casting a substantial tube-like bar and then machining the same externally as well as internally in order to obtain a substantially radially extending extension 11 as well as an internal thread 10 at the end of the body 1 to be connected with the socket 3. The sealing element 2 is fitted on the socket 3 in the region of the cylindrical portion with enhanced external diameter 35 such that after screwing the body 1 onto the socket 3, the same is deformed in a space defined by the projection 32, the cylindrical portion with enhanced external diameter 35, the mating threads 10, 34 and the extension 11. The extension 11 may engage the projection 32, as best seen in FIG. 4.

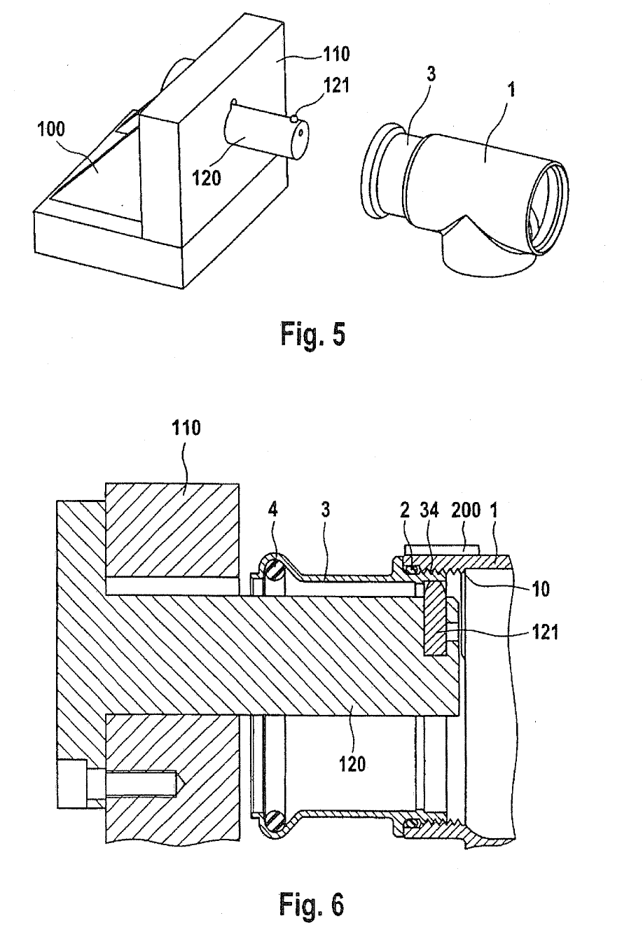

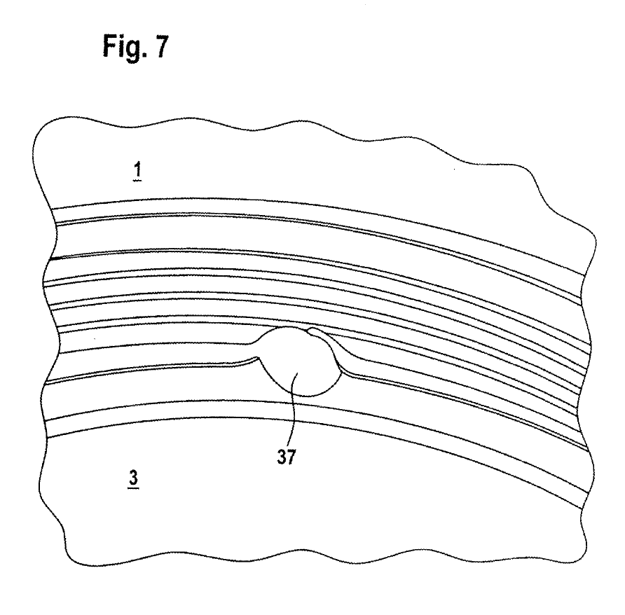

In order to prevent an unscrewing of the mating threads 10, 34, material in the region of said threads 10, 34 is partially deformed by making use of a deformation tool 100 as well as a pressing tool 200 shown in FIGS. 5 and 6. The deformation tool 100 preferably comprises a holding means 110 for a substantially cylindrical bar which is displaceable relative to the holding means 110 along its longitudinal axis and is provided with a substantially radially extending pin 121.

In operation, the socket 3 assembled with the body 1 is loaded onto the bar 120 with its upwardly projecting pin 121. The form of the pin 121 can be of a part of a sphere, whereas other forms are also possible to achieve similar effects, namely deforming the material of the body 1 and the socket 3 in the region of their mating threads 10, 34 between the pin 121 and the pressing tool 200 which can, for example, be a hand-operated press. In other words, a dimple 37 is formed within the material of the socket 3 as well as the material of the body 1 leading to a deformation of the mating threads 10, 34 and, thus, providing an anti-rotational lock between the socket 3 and the body 1, as shown in FIG. 7.

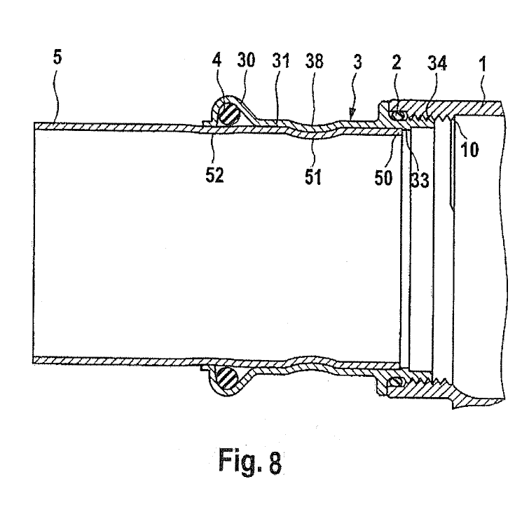

FIG. 8 shows a press connection arrangement with the body 1 being screwed onto the socket 3. The sealing element 2 is arranged between the body 1 and the socket 3 and the threads 10, 34 are partially deformed (not shown). In addition, a tube 5 is inserted into the unit provided by the body 1 and the socket 3 and engages the stop member 33 with its end 50. Further, the socket 3 may be pressed onto said end 50, as can be obtained from the indentations 38, 51 and 52, between which the sealing element 4 is housed within the bead 30, in order to provide a fluid tight seal.

Although modifications and changes may be suggested by those skilled in the art, it is the intention of the application to embody within the patent warranted hereon all changes and modifications as reasonably and probably come within the scope of this contribution to the art. The features disclosed in the description, the figures as well as the claims may be implemented alone or in every combination for the realization of the invention in its different embodiments.

The embodiments of the invention in which an exclusive property or privilege is claimed are defined as follows:

1. A method for producing a press connection arrangement, comprising:
connecting a body to a socket to form a unit of the body and the socket, wherein the body is suited for conditioning a fluid flow within a pipework by re-directing, shutting-off and/or accelerating at least a part of said fluid flow or for providing an adaptation between diameters of different pipework elements,
inserting an end of a tube into at least a part of the unit, and
press-connecting the socket onto the tube in an area of a bead provided by the socket to house a sealing element between the socket and the tube and obtain a press connection arrangement being fluid tight,
wherein said connecting the body to the socket further comprises:
screwing a thread of the body onto a thread of the socket and
at least partially deforming the mating threads to create an anti-rotational lock.

2. The method according to claim 1, wherein the body and the socket are cast and then machined internally as well as externally.

3. The method according to claim 1, wherein the thread of the body is machined on an inner surface of the body and the thread of the socket is machined on an outer surface of the socket.

4. The method according to claim 1, wherein the end of the body to be screwed onto the socket is formed with an extension of enhanced internal diameter and adjacent to the extension, extending substantially axially, the thread of the body is formed as an internal thread, wherein the end of the socket to be screwed into the body is formed with the thread as an external thread and adjacent to the external thread, a substantially cylindrical portion with an enhanced external diameter is bordered by a projection extending substantially radially, and wherein a sealing element in form of an O-ring is fitted onto the cylindrical portion of the socket, prior to the assembly of the body and the socket such that, after screwing the body onto the socket, the sealing element creates a seal between the extension, the threads, the cylindrical portion and the projection in the body and the socket respectively.

5. The method according to claim 4, wherein the body is screwed onto the socket until the extension engages the projection and/or the sealing element is deformed.

6. The method according to claim 1, wherein the threads are deformed substantially along at least one inner perimeter of the unit and/or by forming at least one dimple into the material of both the socket and the body in the region of their threads.

7. The method according to claim 1, wherein the threads are deformed by pressing material of the socket and the body in the region of their threads from the outside of the unit onto at least one deformation element insertable into the unit.

8. The method according to claim 7, wherein said step of at least partially deforming the mating threads further comprises:
inserting the deformation element into the socket until it engages the internal surface of the socket opposite the external thread thereof,
applying a pressing action to the outside of the unit opposite the deformation element to force the material in the region of the threads onto the deformation element,
relieving the pressing action, and
retracting the deformation element out of the unit.

9. The method according to claim 8, wherein said applying a pressing action is repeated after rotating the deformation element relative to the unit in order to form a plurality of dimples into the threads.

10. The method according to claim 1, wherein a stop member for the tube in form of a region of reduced internal diameter of the socket is provided on the inner surface of the socket axially between the projection and the thread.

11. The method according to claim 10, wherein a thickness of the socket is reduced in the area of its thread in order to facilitate the deformation thereof by forming the socket with an enhanced internal diameter from the end thereof until the stop member.

12. A press connection arrangement comprising a body, a socket, and a tube, the body being in form of an elbow, a T-element, an adaptor, a connector, valve and/or an armature, the body being provided with a thread in order to be screwed onto a thread of the socket, wherein mating threads of the body and the socket are at least partially deformed after assembling the socket and the body to provide an anti-rotational lock, and the socket being provided with an annular bead to house a sealing element in form of an O-ring and being pressed onto the tube in the area of the bead under the formation of indentations for a fluid tight connection.

13. The press connection arrangement according to claim 12, wherein a sealing element in form of an O-ring is arranged and/or deformed between the socket and the body in a space defined between the threads, the press connection arrangement further comprising a substantially axially extending extension of the body, a substantially radially projecting projection of the socket, and a substantially cylindrical portion of the socket with enhanced external diameter, the projection and the extension engaging each other.

14. The press connection arrangement according to claim 13, further comprising a stop member in form of a region with reduced internal diameter on the internal surface of the socket for the tube to be inserted into the socket, the stop member being provided between the projection and the thread.

15. The press connection arrangement according to claim 12, wherein the end of the socket to be connected to the body is provided with the thread in the form of an external thread, said end having a reduced thickness and/or enhanced internal diameter.

16. The press connection arrangement according to claim 12, wherein the material of the socket is partially pressed into the material of the body in the region of the threads in form of at least one dimple.

17. The press connection arrangement according to claim 16, wherein a plurality of dimples is provided and arranged along at least one inner perimeter of the socket, the dimples being displaced around the inner perimeter substantially 90° relative to each other.
